(19) United States
(12) Patent Application Publication
(10) Pub. No.: US 2015/0082447 A1
(43) Pub. Date: Mar. 19, 2015

(54) SYSTEM AND METHOD FOR LICENSING A PLURALITY OF SOFTWARE COMPONENTS

(71) Applicant: ROBERT BOSCVH GMBH, Stuttgart (DE)

(72) Inventors: Stefan Schuster, Esslingen (DE); Elena Franke, Oppenweiles (DE)

(21) Appl. No.: 14/376,108

(22) PCT Filed: Jan. 17, 2013
(86) PCT No.: PCT/EP2013/050765

§ 371 Date: Jul. 31, 2014

(30) Foreign Application Priority Data
Feb. 1, 2012 (DE) 10 2012 201 431.4

(51) Int. Cl. G06F 21/12; G06F 21/10

(52) U.S. Cl. CPC G06F 21/12; G06F 21/105
USPC 726/26

(57) ABSTRACT

A method for licensing a plurality of software components on a data processing system, including retrieving a plurality of component-specific identification codes of the plurality of software components by a license management client installed on the data processing system; bundling the component-specific identification codes in a system-specific licensing query by the license management client; sending the system-specific licensing query from the license management client to a license management server assigned to the license management client; extracting the component-specific identification codes from the system-specific licensing query by the license management server for generating component-specific licensing queries; sending the component-specific licensing queries by the license management server to each one of a plurality of licensing services; and receiving component-specific license keys from the plurality of licensing services for licensing the plurality of software components.

### FIELD

The present invention relates to a system and a method for licensing a plurality of software components on a data processing system.

### BACKGROUND INFORMATION

Commercial software products must usually be activated before they may be operated by a user. To ensure authorization by the user, it is often necessary to contact an authorization or authentication office, which verifies the authorization of the user to the software product and carries out the activation of the software product.

For example, a software product may be activated via identification of the computer, on which the software product is being used, by a licensing service, the corresponding licensing and authentication information being transmitted by long-distance data transmission.

If a plurality of software products is installed on a computer system or integrated into an overall approach, different licenses or activations must be carried out by different licensing services for all the software products under some circumstances.

U.S. Patent Application Publication No. US 2010/043075 A1 describes a license manager which monitors the software applications on a computer system and manages a standardized licensing of the software applications by various licensing services.

There is therefore a demand for simple, reliable and user-friendly methods and systems with which a plurality of software components on a data processing system may be licensed, i.e., activated by various licensing services.

### SUMMARY

According to one aspect, the present invention provides an example system for licensing a plurality of software components on a data processing system, having a license management client, which is installed on a data processing system and is designed to retrieve a plurality of component-specific identification codes from a plurality of software components installed on the data processing system and to bundle the component-specific identification codes in a system-specific licensing query; and a license management server assigned to the license management client, the server being connected to the license management client via a long-distance data transmission link and being designed to receive the system-specific licensing query from the license management client via the long-distance data transmission link, to extract the component-specific identification codes from the received system-specific licensing query, to generate component-specific licensing queries from the extracted component-specific identification codes, to send the component-specific licensing queries to each one of a plurality of licensing services and to receive component-specific license keys from the plurality of licensing services for licensing the plurality of software components in response to the component-specific licensing queries.

According to another aspect, the present invention provides an example method for licensing a plurality of software components on a data processing system including retrieval of a plurality of component-specific identification codes of the plurality of software components by a license management client installed on the data processing system, bundling the component-specific identification codes in a system-specific licensing query by the license management client, sending the system-specific licensing query from the license management client to a license management server assigned to the license management client, extracting the component-specific identification codes from the system-specific licensing query for generation of component-specific licensing queries by the license management server, sending the component-specific licensing queries by the license management server to each one of a plurality of licensing services, and receiving component-specific license keys from the plurality of licensing services for licensing the plurality of software components.

In accordance with one example embodiment of the present invention, a modular software solution is licensed, which includes various software components installed on a data processing system, via a centralized licensing system. A license manager is therefore installed as a license management component on the data processing system, which may collect the identification codes of all installed software components and send them in a bundled licensing query to an assigned license management server. Individual queries may then in turn be sent to various licensing services from the license management server to obtain activation codes for the individual installed software components.

One advantage of this procedure is that providers of modular software solutions need not distribute the information about the modular structure of the software solutions from users to suppliers of software components in advance. Furthermore, the individual software components need not be adapted to the overall system but instead their licensing procedures may be largely retained.

Therefore, it is not necessary to create special versions of modular software solutions, whose specialized licensing modalities would have to be managed in a complex manner. Nor is it necessary for software components having preinstalled licenses to be supplied, so that providers of modular software solutions continue to retain control over the overall product, and unauthorized reproduction of the product is made difficult.

Another advantage is that a uniform licensing procedure may take place without the user having to be concerned with the tedious details of various licensing procedures. It is particularly advantageous here that by bundling the licensing procedures, a collective licensing query may initially be placed, and then the actual activation of the software components occurs only when the licensing of all software components has been successfully concluded. This is achieved by the fact that the license management client and the license management server act as mediators capable of monitoring the accuracy and thoroughness of all licensing steps. Therefore it cannot happen that only some of the software components of a modular software system are licensed while other parts are not licensed yet or are not licensed correctly. This greatly reduces the susceptibility of the entire licensing procedure to errors.

According to one specific embodiment of the system according to the present invention, the license management server may also be designed to bundle the component-specific license keys in a system-specific licensing response and send it to the license management client, and the license management client may also be designed to extract the component-specific license keys from the received system-specific licensing response and to activate the plurality of software components with the aid of the component-specific license keys.

According to another specific embodiment of the system according to the present invention, the license management client may have a plurality of component adapters, which are coupled to each one of the plurality of software components, and each of which is designed to retrieve the component-specific identification code of the assigned software component and to transfer the component-specific license key for the assigned software component to the software component.

According to one specific embodiment of the method according to the present invention, the component-specific license keys may also be bundled in a system-specific licensing response by the license management server, the system-specific licensing response may be sent from the license management server to the license management client, the component-specific license keys may be extracted from the system-specific licensing response by the license management client, and the plurality of software components may be activated by the license management client with the aid of the component-specific license keys.

According to another specific embodiment of the method according to the present invention, the plurality of software components may be activated by the license management client with the aid of the component-specific license keys only if there is a valid component-specific license key for each of the software components in the license management client. It may then be advantageously ensured that partial licensing of individual software components of a modular software solution is impossible. This greatly reduces the susceptibility of the software system to errors since the functionality of the modular software solution may be activated as a whole under the control of the license management client.

According to another specific embodiment of the method according to the present invention, the component-specific licensing queries may be sent by the license management server to each one of a plurality of licensing services via long-distance data transmission links to the licensing services over a network. This may yield the advantage that the actual component authentication and authorization may remain in the hands of the various component manufacturers—only the combination and verification of the validity of the combination of license keys are subject to the control by the license management server and thus to the control of a provider of modular software solutions.

According to an alternative specific embodiment of the method according to the present invention, component-specific licensing queries may be sent by the license management server to each one of a plurality of licensing services via data links to the licensing services within the license management server.

According to another specific embodiment of the method according to the present invention, system-specific user information may also be appended to the system-specific licensing query by the license management client.

Additional features and advantages of specific embodiments of the present invention are derived from the following description with reference to the figures.

### BRIEF DESCRIPTION OF THE DRAWINGS

The example embodiments and refinements described here may be arbitrarily combined with one another, if reasonable. Other possible embodiments, refinements and implementations of the present invention also include combinations not mentioned explicitly of features described above or below with respect to the exemplary embodiments.

The figures should impart a further understanding of the specific embodiments of the present invention. They illustrate specific embodiments and are used in conjunction with the description of the explanation of principles and concepts of the present invention. Other specific embodiments and many of the advantages mentioned are derived with regard to the figures. The elements of the figures are not necessarily drawn to scale with one another.

FIG. 1 shows a schematic illustration of a network environment according to one specific embodiment.

FIG. 2 shows a schematic illustration of a sequence diagram for carrying out a method for licensing a plurality of software components of a data processing system according to another specific embodiment.

### DETAILED DESCRIPTION OF EXAMPLE EMBODIMENTS

Speaking in general terms, software components and also a license management client as described herein may have logic and/or data which are retrievable by a device, a medium or a data medium or may be transferred by a data signal. For example, the software components and/or the license management client may have instructions in the sense of this patent application, which, when executed, compiled and/or read out, cause steps to be carried out on a data processing system, which are advantageous and/or necessary for the execution of the functions, measures and procedures relevant for the present invention.

Specific example embodiments of the present invention may be provided as methods or devices, which may be designed as software, hardware, firmware or combinations thereof by conventional programming techniques or IT techniques. Specific embodiments of the present invention in particular may also include computer program products having logic and/or data, which may be made accessible by a computer-readable medium, a computer-readable data medium or a computer-readable data memory.

Data processing systems as described herein may include any type of electronic systems, which have a central unit and peripheral devices and are capable of receiving, storing, processing and delivering data in an independent or generally independent manner. Data processing systems may include, for example, PCs, smartphones, laptops, notebooks, universal computers, network computers, workstations, PDAs, system installations, automation systems or similar systems.

Servers as described herein may include all hardware-based or software-based equipment, usually accessible via long-distance data transmission, providing access to one or multiple services, usually information services for a plurality of clients.

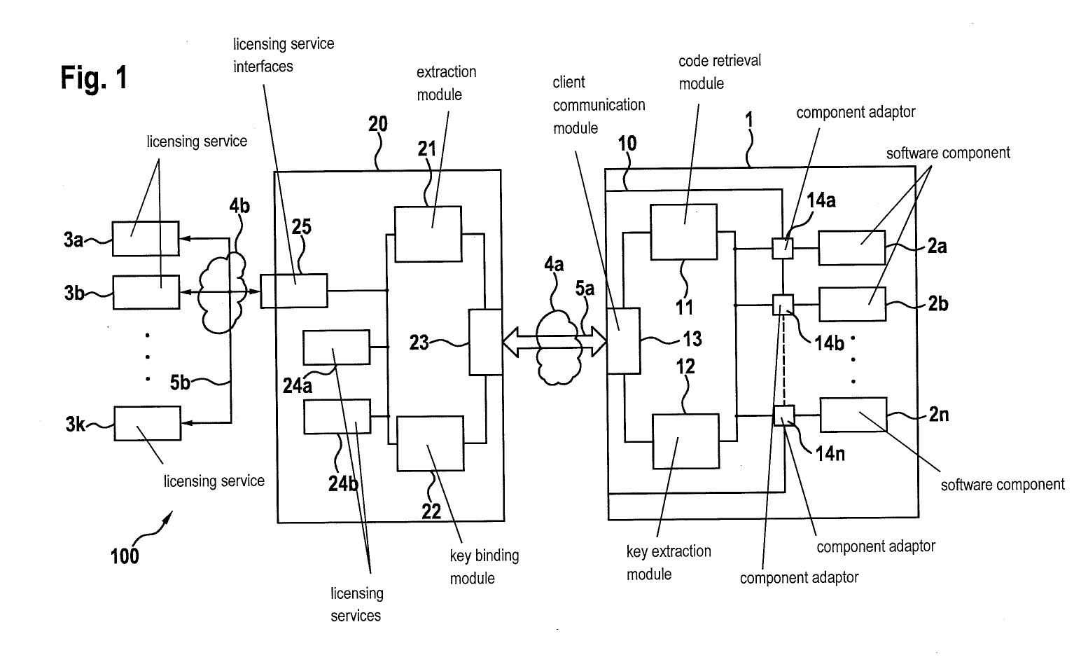

FIG. 1 shows a schematic illustration of a network environment 100 having a license management server 20 and a data processing system 1. A plurality of software components 2a, 2b, . . . , 2n may be installed on the data processing system and may be part of a modular software solution or an overall software product. In addition, a license management client 10 may also be installed on data processing system 1.

License management client 10 may be designed to retrieve a plurality of component-specific identification codes from software components 2a, 2b, . . . , 2n and to bundle the component-specific identification codes in a system-specific licensing query. For this purpose, license management client 10 may have a plurality of component adapters 14a, 14b, . . . , 14n, each being linked to each one of the plurality of software components 2a, 2b, . . . , 2n. Component-specific identification codes of assigned software components 2a, 2b, . . . , 2n may be retrieved via component adapters 14a, 14b, . . . , 14n.

Component-specific identification codes may be MAC codes, activation codes, registration keys or other alphanumeric codes which are suitable for unambiguous identification of a software component or for cryptographic identification of the corresponding installation. Component-specific identification codes are often referred to as “seeds.”

License management client 10 may have a code retrieval module 11, which is able to retrieve the component-specific identification codes of software components 2a, 2b, . . . , 2n via component adapter 14a, 14b, . . . , 14n. The component-specific identification codes may be bundled in code retrieval module 11 to form a system-specific licensing query, i.e., to form a code container, which is assigned to corresponding data processing system 1 and includes all component-specific identification codes. The code container may be present in XML format, for example.

The system-specific licensing query may be sent by license management client 10 to license management server 20 assigned to license management client 10 via a long-distance data transmission link 5a of a network 4a using a client communication module 13. Long-distance data transmission link 5a may be a TCP/IP link, for example, and network 4a may be the Internet.

License management server 20 may have a corresponding server communication module 23 to receive system-specific licensing queries from license management client 10 via long-distance data transmission link 5a. The component-specific identification codes may be extracted from the received system-specific licensing query in an extraction module 21. Component-specific licensing queries, which are sent by license management server 20 to each one of a plurality of licensing services 3a, 3b, . . . , 3k or 24a, 24b, may be generated in extraction module 21 with the aid of the extracted component-specific identification codes.

Licensing services 3a, 3b, . . . , 3k may have licensing servers from third party providers, for example, which are connected via additional long-distance data transmission links 5b to license management server 20 via a network 4b. For this purpose, license management server 20 may have one or multiple licensing service interfaces 25. Alternatively or additionally, it may also be possible for licensing services 24a, 24b to already be present in license management server 20, for example, the provider of proprietary licensing services. In this case, the licensing query may be processed directly in license management server 20.

Licensing services 3a, 3b, . . . , 3k or 24a, 24b may receive the component-specific licensing queries and process them further. For example, user information, access authorizations, authorization information or the like may be checked in licensing services 3a, 3b, . . . , 3k or 24a, 24b. If the component-specific identification codes contained in the corresponding component-specific licensing query are recognized as being valid, then licensing services 3a, 3b, . . . , 3k or 24a, 24b may each generate component-specific license keys, which may be transmitted back to license management server 20. License management server 20 may receive the component-specific license keys for licensing the plurality of software components 2a, 2b, . . . , 2n in response to the component-specific licensing queries.

License management server 20 may also have a key bundling module 22, with the aid of which the component-specific license keys are bundled in a system-specific licensing response, which may in turn be sent back to associated license management client 10 over long-distance data transmission link 5a. This license management client 10 may in turn have a key extraction module 12, which extracts the component-specific license key from the system-specific licensing response. With the aid of the component-specific license key, the plurality of software components 2a, 2b, . . . , 2n may then be activated or licensed by license management client 10. For this purpose, license management client 10 may therefore transmit the component-specific license keys to corresponding software components 2a, 2b, . . . , 2n using component adapters 14a, 14b, . . . , 14n.

It may be provided here that activation of the plurality of software components 2a, 2b, . . . , 2n takes place with the aid of the component-specific license keys by license management client 10 only when a valid component-specific license key for each software component 2a, 2b, . . . , 2n is present in license management client 10. In particular when the authentication or identification of individual software components 2a, 2b, . . . , 2n by corresponding licensing services 3a, 3b, . . . , 3k or 24a, 24b fails, licensing of the other software components may be delayed until the problems are solved and a complete licensing of all software components 2a, 2b, . . . , 2n of the modular software solution is possible at the same time. Partial licensing and the associated non-functionality of the overall software system may thus be avoided.

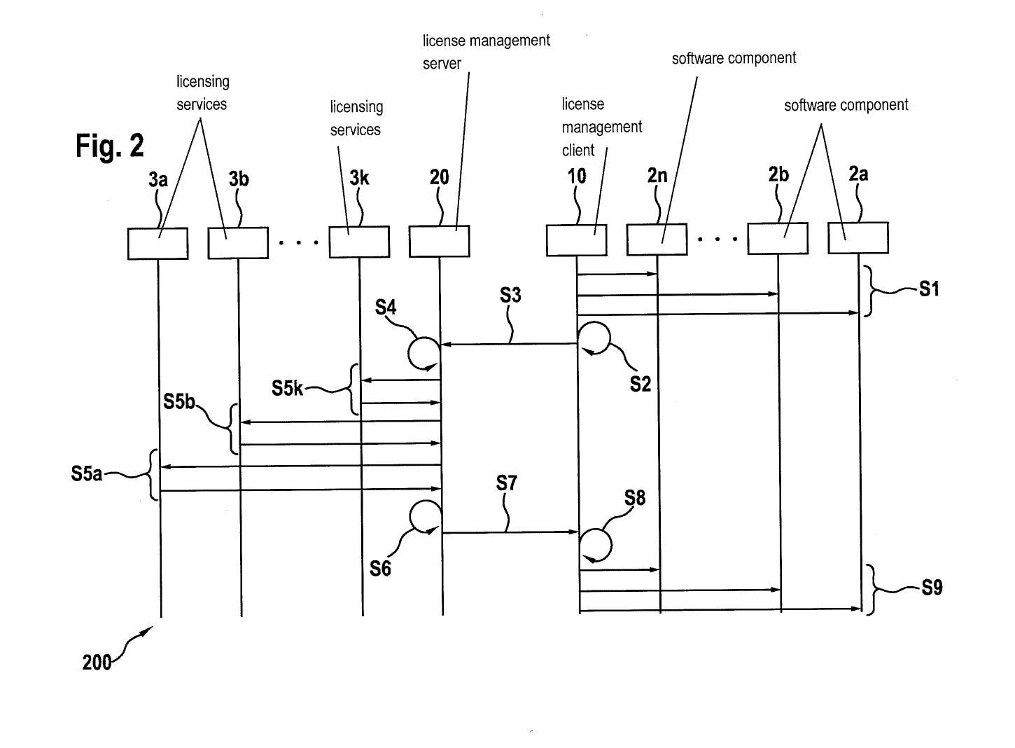

FIG. 2 shows a schematic illustration of a sequence diagram for carrying out a method 100 for licensing a plurality of software components on a data processing system, in particular utilizing a license management client 10 and a license management server 20 on a data processing system 1, as illustrated in FIG. 1.

In a first step S1, a plurality of component-specific identification codes may be retrieved by the plurality of software components 2a, 2b, . . . , 2n by a license management client 10 installed on data processing system 1. These component-specific identification codes may be bundled by license management client 10 in a system-specific licensing query in a step S2.

In step S3, the system-specific licensing queries may be sent by license management client 10 to a license management server 20 assigned to license management client 10, this server being able to extract the component-specific identification codes from the system-specific licensing query in a step S4 to generate component-specific licensing queries. The extracted component-specific licensing queries may be transmitted to various licensing services in substeps S5a, S5b, . . . , S5k. Examples here include only the licensing services external to license management server 20, but similar substeps may also be carried out for internal licensing services within license management server 20, for example, licensing services corresponding to licensing services 24a, 24b in FIG. 1.

After processing the component-specific licensing queries in the licensing services, they may send component-specific license keys back to license management server 20 in response to the queries. The component-specific license keys may be used to license each one of a plurality of software components 2a, 2b, . . . , 2n.

In a step S6, the component-specific license keys may then be bundled by license management server 20 in a system-specific licensing response and may be transmitted by license management server 20 to license management client 10 in a step S7. The client may then extract the component-specific license keys from the system-specific licensing response in a step S8 and activate or license the plurality of software components 2a, 2b, . . . , 2n with the aid of component-specific license keys in a step S9. Step S9 may be carried out in particular only when a valid component-specific license key is available for each software component 2a, 2b, . . . , 2n in license management client 10.

Through this procedure, the licensing of the entire modular software system may take place in one sequence without the user having to activate each individual software component in a tedious procedure, which is subject to errors. At the same time, the software components remain flexible since the licensing modalities of each individual software component need not be modified in particular with regard to integration into the overall software system. This has a direct influence on the efficiency of development of the individual software components because the various components need not be shifted to a standardized activation and licensing mechanism. This also eliminates the need for managing various versions of modular software solutions which have different activation and licensing mechanisms.

1-9. (canceled)

10. A method for licensing a plurality of software components on a data processing system, comprising:
retrieving a plurality of component-specific identification codes of the plurality of software components by a license management client installed on the data processing system;
bundling the component-specific identification codes in a system-specific licensing query by the license management client;
sending the system-specific licensing query by the license management client to a license management server assigned to the license management client;
extracting the component-specific identification codes from the system-specific licensing query for generating component-specific licensing queries by the license management server;
sending the component-specific licensing queries by the license management server to each one of a plurality of licensing services; and
receiving component-specific license keys from the plurality of licensing services for licensing the plurality of software components.

11. The method as recited in claim 10, further comprising:
bundling the component-specific license keys in a system-specific licensing response by the license management server;
sending the system-specific licensing response from the license management server to the license management client;
extracting the component-specific license keys from the system-specific licensing response by the license management client; and
activating the plurality of software components by the license management client with the aid of the component-specific license keys.

12. The method as recited in claim 11, wherein the plurality of software components is activated with the aid of the component-specific license keys by the license management client when a valid component-specific license key is present in the license management client for each software component.

13. The method as recited in claim 10, wherein the component-specific licensing queries are sent by the license management server to each one of a plurality of licensing services via long-distance data transmission links to the licensing services via a network.

14. The method as recited in claim 10, wherein the component-specific licensing queries are sent by the license management server to each one of a plurality of licensing services via data links to the licensing services within the license management server.

15. The method as recited in claim 10, further comprising:
appending system-specific user information to the system-specific licensing query by the license management client.

16. A system for licensing a plurality of software components on a data processing system, comprising:
a license management client installed on a data processing system and designed to retrieve a plurality of component-specific identification codes of a plurality of software components installed on the data processing system and to bundle the component-specific identification codes in a system-specific licensing query; and
a license management server assigned to the license management client and connected to the license management client via a long-distance data transmission link and designed to receive the system-specific licensing query from the license management client via the long-distance data transmission link, to extract the component-specific identification codes from the received system-specific licensing query, to generate component-specific licensing queries from the extracted component-specific identification codes, to send the component-specific licensing queries to each one of a plurality of licensing services, and to receive component-specific license keys from the plurality of licensing services for licensing the plurality of software components in response to the component-specific licensing queries.

17. The system as recited in claim 16, wherein the license management server is also designed to bundle the component-specific license keys in a system-specific licensing response and to send them to the license management client, and the license management client being also designed to extract the component-specific license keys from the received system-specific licensing response and to activate the plurality of software components with the aid of the component-specific license keys.

18. The system as recited in claim 17, wherein the license management client has a plurality of component adapters, which are linked to each one of the plurality of software components and are designed to retrieve the component-specific identification code of the assigned software component and to transmit to the software component the component-specific license key for the assigned software component.
